(19) United States
(12) Patent Application Publication
(10) Pub. No.: US 2023/0088379 A1
(43) Pub. Date: Mar. 23, 2023

(54) Composite Paper-Based Sorbents For CO2 Capture

(71) Applicant: Carbon Sink Inc., Lloyd Harbor, NY (US)

(72) Inventors: Shawn Mortimore, Kalamazoo, MI (US); Karin Yaccato, Oakland, CA (US); John Bergin, Wisconsin Rapids, WI (US); Raffaella Sordella, Cold Spring Harbor, NY (US); Frank T. O'Keefe, Lloyd Harbor, NY (US)

(21) Appl. No.: 18/053,637

(22) Filed: Nov. 8, 2022

Related U.S. Application Data
(60) Provisional application No. 63/276,985, filed on Nov. 8, 2021.
(60) Provisional application No. 63/087,503, filed on Oct. 5, 2020.
(60) Provisional application No. 62/909,937, filed on Oct. 3, 2019.
(60) Provisional application No. 62/740,317, filed on Oct. 2, 2018.
(60) Provisional application No. 62/546,807, filed on Aug. 17, 2017.

(51) Int. Cl. B01J 41/05; B01J 41/12; B01J 47/127; B01J 47/014; B01D 53/02

(52) U.S. Cl. CPC B01J 41/05; B01J 41/12; B01J 47/127; B01J 47/014; B01D 53/02; B01D 2253/206; B01D 2253/25; B01D 2257/504

(57) ABSTRACT

Disclosed herein are compositions and methods for manufacturing composite paper-based sorbents configured for durability, and high surface area exposure to air. Composite paper-based sorbents can comprise fibers (e.g. natural and/or synthetic fibers), anion exchange resins, and additives. Composite paper-based sorbents can be configured for durability when used in various forming processes, e.g., corrugation, and when used under a variety of conditions, for example, in high and low humidity environments.

### BACKGROUND

The disclosed invention relates to the field of carbon capture technologies and, in particular, to the field of carbon capture from ambient air using composite paper-based CO₂ sorbents.

### SUMMARY

Disclosed herein are flexible sheets of a composite material adapted to adsorb carbon dioxide from a gaseous flow comprising: 40% to 80% by weight of a fiber component and 10% to 50% by weight of a strong base anion exchange resin component formulated into a sheet material having a weight ranging from about 100 gsm to about 400 gsm.

In some embodiments, the strong base anion exchange resin is a Type I strong base anion exchange resin. In some embodiments, the Type I strong base anion exchange resin is selected from the group consisting of Purolite® A500, Dowex™ Marathon™ A (OH form), ResinTech SBMP1 (OH form), Rohm & Haas Amberlite IRA402 (OH form), and Rohm & Haas Amberlite 900 (OH form). In some embodiments, the fiber component comprises about 35% to about 65% by weight of a natural fiber and about 35% to about 65% by weight of a synthetic fiber. In some embodiments, the fiber component comprises a natural fiber selected from the group consisting of lignocellulosic fibers, natural fibers derived from wood, wheat, rice, reed, hemp, flax, cotton, bagasse, bamboo, grass, sorghum, or kenaf, a recovered fiber, and recycled fiber, or any combination thereof. In some embodiments, the lignocellulosic fiber is selected from the group consisting of cellulose, hemicellulose, and lignin. In some embodiments, the fiber component comprises a synthetic fiber selected from the group consisting of polyester fiber, polyolefin fiber, acrylic fiber, aramid fiber, 5d30, cyphrex, and vinylon, or any combination thereof. In some embodiments, the polyolefin fiber is polypropylene or polyethylene. In some embodiments, the fiber component comprises about 27% to 33% by weight of cotton and about 27% to 33% by weight of 1.5 polyester. In some embodiments, the flexible sheet further comprises one or more process additives selected from the group consisting of retention and drainage aids, biocides, dispersants, and defoamers. In some embodiments, the flexible sheet further comprises one or more functional additives selected from the group consisting of fillers, binders, bonding agents, thickening and stabilizing agents, sizing agents, wet-strength additives, and dry-strength additives. In some embodiments, the one or more functional additives are selected from the group consisting of wet strength additives, cationic starches, and guar gum. In some embodiments, the one or more functional additives comprise polyamide epichlorohydrin (PAE). In some embodiments, the flexible sheet further comprises about 1% to 2% by weight of polyamide epichlorohydrin (PAE). Also disclosed are collector systems for the capture of CO₂ from ambient air, wherein the collector system comprises any of these flexible sheet materials.

Disclosed herein are flexible sheets of a material adapted to adsorb carbon dioxide from a gaseous flow, wherein said material is formed by a process comprising: (1) combining 20% to 40% by weight of a natural fiber, 20% to 40% by weight of a synthetic fiber, 10% to 50% by weight of a strong base anion exchange resin, and 5% to 20% by weight of a liquid to form a slurry; (2) forming a wet sheet by distributing the slurry onto a planar flat surface; and (3) simultaneously and/or sequentially draining liquid from the distributed slurry, applying pressure to the wet sheet, and drying the wet sheet.

In some embodiments, the natural fiber is selected from the group consisting of cellulosic fibers and natural fibers derived from wood, wheat, rice, reed, hemp, flax, cotton, bagasse, bamboo, grass, sorghum, kenaf, a recovered fiber, and recycled fiber, or any combination thereof. In some embodiments, the cellulosic fiber is cellulose or hemicellulose. In some embodiments, the synthetic fiber is selected from the group consisting of polyester fiber, polyolefin fiber, acrylic fiber, aramid fiber, 5d30, cyphrex, and vinylon, or any combination thereof. In some embodiments, the polyolefin fiber is polypropylene or polyethylene. In some embodiments, the strong base anion exchange resin is a Type I strong base anion exchange resin. In some embodiments, the Type I strong base anion exchange resin is selected from the group consisting of Purolite® A500, Dowex™ Marathon™ A (OH form), ResinTech SBMP1 (OH form), Rohm & Haas Amberlite IRA402 (OH form), and Rohm & Haas Amberlite 900 (OH form). Also disclosed are collector systems for the capture of CO₂ from ambient air, wherein the collector system comprises any of these flexible sheet materials.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates the process of CO₂ adsorption and desorption from an anion exchange resin. CO₂ is adsorbed from ambient air under dry conditions, and released upon wetting or an increase in humidity.

FIG. 2 provides examples of scanning electron micrographs of one non-limiting example of a composite paper-based CO₂ capture material comprising Purolite A500 (OH form) anion exchange resin.

FIG. 3 provides a non-limiting example of data illustrating the uptake and release of CO₂ by a composite paper-based sorbent comprising Purolite A500 (OH form) anion exchange resin. Tests were performed in a closed-loop, laboratory-scale environmental chamber.

FIG. 4 illustrates a commercial paper-making process which may be used to form composite paper-based CO₂ sorbents, and a secondary process such as corrugation that may be used to form the paper-based CO₂ sorbent materials of the present disclosure into macrostructured configurations suitable for use in extractor devices, e.g., CO₂ capture devices for capturing CO₂ from ambient air.

FIG. 5 illustrates the structure of a corrugated composite paper-based sorbent material.

FIG. 6 illustrates one non-limiting example of a CO₂ extraction device that utilizes the composite paper-based sorbent materials of the present disclosure for capture of CO₂ from ambient air, and delivery of the CO₂ to the interior of a greenhouse.

FIG. 7 is a plot of the pre-wash Tearing Index values for samples 1-9.

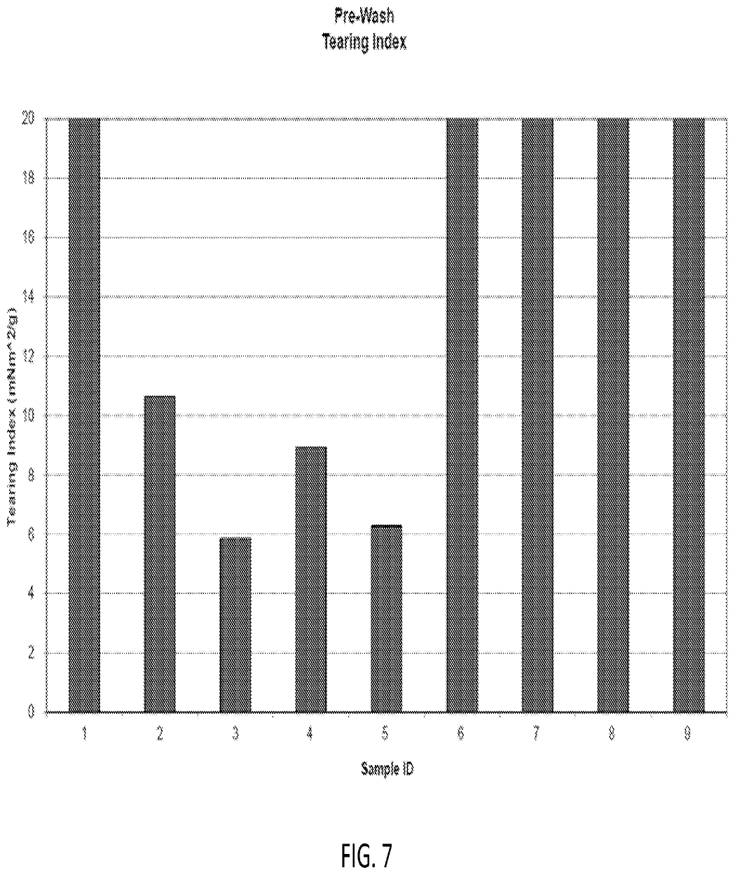

FIG. 8 is a plot of the pre-wash Dry Tensile Index for samples 1-9.

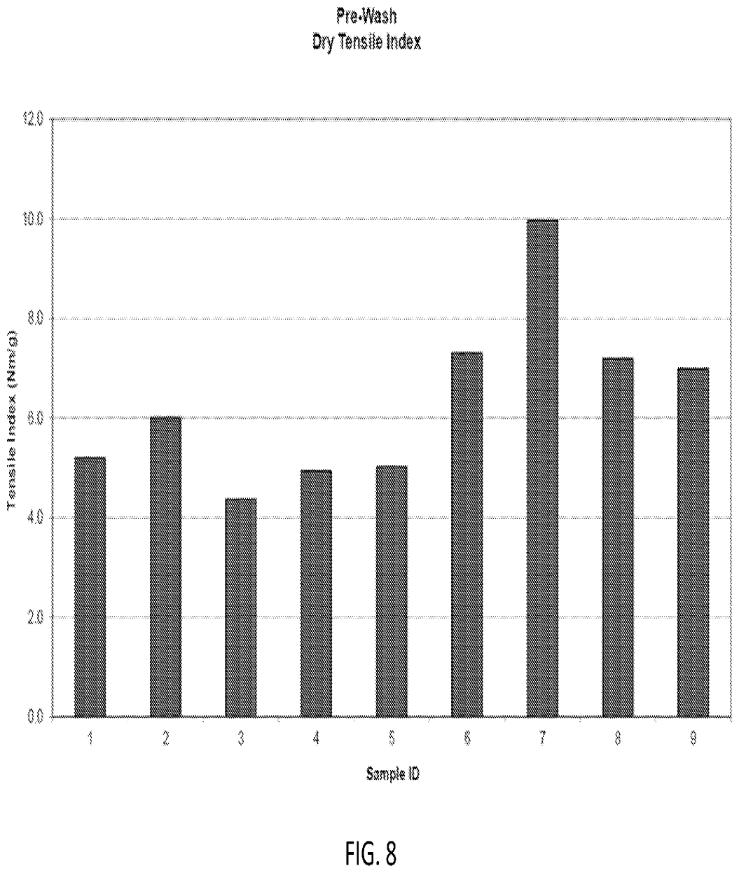

FIG. 9 is a plot of the pre-wash Wet Tensile Index for samples 1-9.

FIG. 10 is a plot of the pre-wash Gurley Porosity values for samples 1-9.

FIG. 11 is a plot of the pre-wash Dry Elongation values for samples 1-9.

FIG. 12 is a plot of the pre-wash Wet Elongation values for samples 1-9.

FIG. 13 is a plot of the pre-wash Dry TEA values for samples 1-9.

FIG. 14 is a plot of the pre-wash Wet TEA values for samples 1-9.

FIG. 15 is a plot of the post-wash Dry Tensile Index values for samples 4-9.

FIG. 16 is a plot of the post-wash Wet Tensile Index values for samples 4-9.

FIG. 17 is a plot of the post-wash Gurley Porosity values for samples 4-9.

FIG. 18 is a plot of the post-wash Dry Elongation values for samples 4-9.

FIG. 19 is a plot of the post-wash Wet Elongation values for samples 4-9.

FIG. 20 is a plot of the post-wash Dry TEA values for samples 4-9.

FIG. 21 is a plot of the post-wash Wet TEA values for samples 4-9.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Composite paper-based sorbents: Paper-based sorbents (also referred to herein as “composite paper-based sorbents”) are disclosed which may be used as a substrate to adsorb and transfer carbon dioxide from one environment to another. In some instances, release of carbon dioxide from the sorbent can be triggered in response to exposure of the paper-based sorbent to liquid or water vapor (e.g., humidity changes, immersion in liquid, etc.) such that there is a net transfer of carbon dioxide from, for example, ambient air (i.e., outdoor or atmospheric air) of a relatively low humidity to air within an enclosed structure (e.g., indoor air or greenhouse air) that has a higher humidity. The material properties of paper-based sorbents are critical to the application of these materials in devices and systems that can capture CO₂ and utilize it for alternative purposes.

The present invention in one aspect provides an improvement over prior art sorbents and systems for capture of CO₂ from air by the utilization of solid phase anion exchange media incorporated into a composite paper-based material for the direct capture of CO₂ (and potentially other acid gases such as NOx and SO₂) from air. Specifically, this invention provides practical physical configurations of the active element (the anion exchange resin), formulations and processes for the manufacture of the composite paper-based sorbent comprising the active element, and configuration options for incorporation of the composite paper-based sorbent into air collector devices to facilitate the direct capture of CO₂ and other acid gases from ambient air (or other gas mixtures) based on solid phase, anion exchange materials.

Several of the key challenges associated with producing effective paper-based sorbents are (i) the need for high CO₂ binding capacity (e.g., moles of CO₂ bound per gram of material), (ii) the need for efficient CO₂ release in response to environmental stimuli such as changes in temperature and/or humidity, and (iii) the need for compatibility with fabrication techniques used to create high surface area macrostructures that promote maximal contact between air or another gas mixture and the CO₂ capture component of the composite paper, and have a high density of air flow channels, low resistance to air flow, etc., to facilitate efficient exposure of the CO₂ binding agents within the paper-based sorbent to large amounts of air.

Air permeability and tensile energy absorption in the dry and wet state are properties of particular importance for formulating paper-based sorbents. Effective paper-based sorbents can comprise enhanced quantities of an anion exchange resin that impart the CO₂ binding capability, and paper-making components that impart the material properties that support resin accessibility and paper durability under wet and dry conditions, where the overall formulation is optimized to support the aim of fabricating devices that deliver improved carbon dioxide transfer capabilities. To promote efficient capture and release of CO₂ (or other gases) by devices comprising a paper-based sorbent material, the resin pore structure and surface area, the composite paper matrix that supports the active resin, and the formation of macro-scale structures that can be conveniently configured for compatibility with extraction and collection device designs are all important considerations.

Developing a durable paper-based sorbent that meets the requirements for high CO₂ binding capacity, efficient CO₂ release, and compatibility with fabrication techniques for creating macrostructures with high surface area poses distinct technical challenges. For example, sufficient quantities of a carbon dioxide adsorbent resin must be included in the material to achieve the CO₂ binding capacity target, without having such a deleterious effect on the mechanical properties of the composite paper that it is no longer compatible with common fabrication methods for forming and shaping the resulting resin-doped material. Furthermore, the resin incorporated into the composite paper must be accessible to the air or gas mixture. In general, as noted above, the resin itself will have a porosity (or pore structure) that provides ready access by air to the chemically-active (i.e., not blocked) functional groups that are responsible for adsorption of CO₂ or other gases. The composite paper matrix must then be formulated to incorporate and support very high concentrations of resin without occluding access to the resin particles. Finally, the composite paper product must be compatible with industrial-scale processes for shaping/forming the material into macrostructures that maximize exposed surface area while minimizing the pressure drop of air (or other gas mixtures) flowing through the structures. Therefore, it can require significant technical skill to develop and produce a product that has the structural integrity to withstand, for example, corrugation, creping or embossing processes, while ensuring resin retention and resin surface accessibility, and thus providing carbon dioxide adsorption sites that are exposed to air.

The manufacturing methods and compositions disclosed herein can be configured to produce a composite paper-based sorbent comprising one or more types of fiber, one or more types of anion exchange resin, and one or more types of additive. In some instances, the disclosed composite paper-based sorbents may optionally be attached to a backer sheet using an adhesive. In some embodiments, the paper-based sorbents may be configured to withstand changes in specific environmental conditions, including changes in humidity and temperature. In some embodiments, the paper-based sorbents may also be configured to exhibit specific material properties that are compatible with shaping the material into high surface area macrostructures, for example through methods including corrugation, creping, or embossing. The material properties of the disclosed paper-based sorbents may be characterized using any of a variety of measurement techniques known to those of skill in the art, as will be described in more detail below. The paper-based sorbents may also be configured to exhibit durability, and to maximize the anion exchange capacity (in terms of milliequivalents of exchangeable ions/gram or millimoles of exchangeable ions/g) and/or the carbon dioxide binding capacity (in terms of grams or moles of adsorbed CO₂/gram) of the material. The CO₂ capture and performance characteristics of paper-based sorbents may be characterized using one or more experimental and/or theoretical parameters and measurement techniques known to those of skill in the art, including measurement of equilibrium binding curves, limits of operation, reaction rates, and thermodynamic calculations.

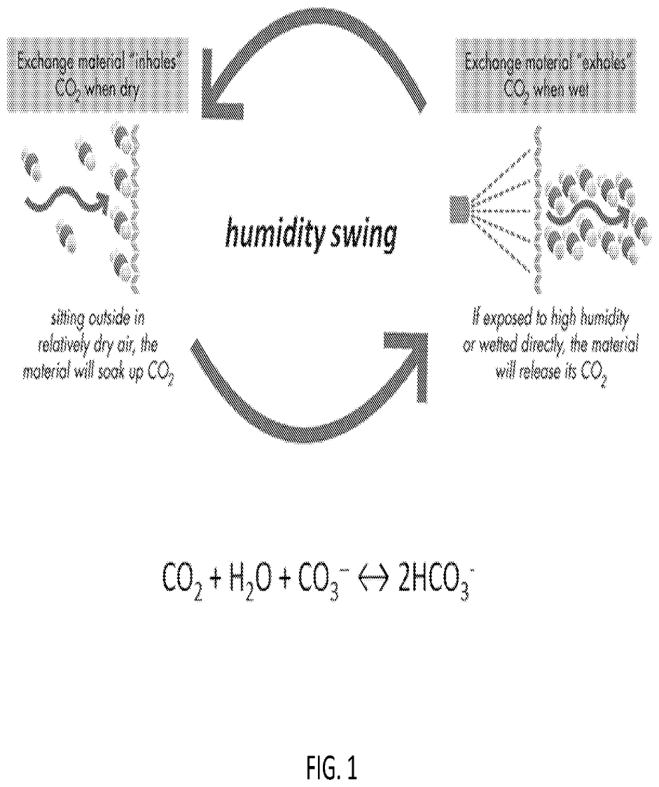

Response to changes in humidity: In some embodiments, for example when the anion exchange component of the composite paper comprises a strong-base, Type 1 anion exchange resin, the disclosed paper-based sorbents, or devices configured to use the paper-based sorbents, may be formulated or configured to perform gas exchange as a result of a humidity swing effect. Under these conditions, the paper-based sorbent can operate as a gas exchange material, as shown in FIG. 1, and changes in humidity (e.g., a humidity swing) can result in the exchange of a gas (e.g., carbon dioxide, CO₂) in response to changes in environmental conditions. Under dry conditions paper-based sorbents can “inhale” a gas involved in the exchange by soaking up the gas from a mixture of gasses (e.g., ambient air) such that the gas can adsorb to the surface of the paper-based sorbent (i.e., to the exposed surfaces of the anion exchange resin particles contained therein). The paper-based sorbent with the adsorbed gas can then be transferred to an environment of higher humidity (or high water vapor pressure), or the paper-based sorbent can be wetted directly (e.g., with liquid water, spraying, or misting). Upon exposure to higher levels of liquid water, water vapor, or humidity, the exchange material can “exhale” or release the gas. The gas adsorption/desorption reactions involved in the capture and release of CO₂ via a humidity swing mechanism can be fully reversible. In some embodiments, the adsorption of CO₂ by the sorbent may fully saturate at ambient concentrations as low as 100 ppm of carbon dioxide. In some instances, the humidity swing may be implemented using low energy processes that are fueled by the evaporation of water. In some instances, the humidity swing (or increase in humidity) required to release an adsorbed gas from the paper-based sorbent may range from about a 10% increase in relative humidity to about a 90% increase in relative humidity. In some instances, the humidity swing (or increase in humidity) required to release an adsorbed gas from the paper-based sorbent (e.g., to transition from about 90% saturation of binding sites to about 10% saturation) may be an at least 10%, at least 20%, at least 30%, at least 40%, at least 50%, at least 60%, at least 70%, at least 80%, or at least 90% increase in relative humidity. In some embodiments, the humidity swing (or increase in humidity) required to release an adsorbed gas from the paper-based sorbent (e.g., to transition from about 90% saturation of binding sites to about 10% saturation) may be an at most 90%, at most 80%, at most 70%, at most 60%, at most 50%, at most 40%, at most 30%, at most 20%, or an at most 10% increase in relative humidity. Those of skill in the art will recognize that the humidity swing (or increase in humidity) required to release an adsorbed gas from the paper-based sorbent may have any value within this range, e.g., an increase in relative humidity of about 36%. In some embodiments, the change in humidity required to release an adsorbed gas from the paper-based sorbent may depend on how the endpoints of the transition are defined, e.g., a transition from about 90% saturation of binding sites to about 10% saturation may require a different increase in humidity than a transition from about 80% saturation to about 20% saturation. In some embodiments, the change in humidity required to trigger the transition between adsorption of CO₂ to release of CO₂ may further depend on the ambient temperature.

Response to changes in temperature: In some embodiments, for example when the anion exchange component of the composite paper comprises a Type 1 or Type 2 anion exchange resin, the disclosed paper-based sorbents, or devices configured to use the paper-based sorbents, may be formulated or configured to perform gas exchange as a result of a change in temperature (i.e., a temperature jump or temperature effect). Under these conditions, the paper-based sorbent can operate as a gas exchange material and changes in temperature can result in the exchange of a gas (e.g., carbon dioxide, CO₂) in response to changes in environmental conditions. In these embodiments, the paper-based sorbent would preferentially adsorb CO₂ or other gases from air or gas mixtures at low temperatures, and would preferentially release CO₂ (or other adsorbed gases) at high temperatures. In general, the transition from CO₂ (or other gas) adsorption to CO₂ (or other gas) release may be triggered by changes (increases) of temperature ranging from about 10 degrees to about 90 degrees, or more. In some embodiments, the change (increase) in temperature required to trigger the transition from gas adsorption to gas release (e.g., to transition from about 90% saturation of binding sites to about 10% saturation) may be at least 10 degrees, at least 20 degrees, at least 30 degrees, at least 40 degrees, at least 50 degrees, at least 60 degrees, at least 70 degrees, at least 80 degrees, or at least 90 degrees. In some embodiments, the change in temperature required to trigger a transition may be at most 90 degrees, at most 80 degrees, at most 70 degrees, at most 60 degrees, at most 50 degrees, at most 40 degrees, at most 30 degrees, at most 20 degrees, or at most 10 degrees. Those of skill in the art will recognize that in specific embodiments, the change in temperature required to trigger a transition may have any value within this range, e.g., about 35 degrees. In some embodiments, the change in temperature required to trigger a transition from gas adsorption to gas release may depend on how the endpoints of the transition are defined, e.g., a transition from about 90% saturation of binding sites to about 10% saturation may require a different increase in temperature than a transition from about 80% saturation to about 20% saturation. In some embodiments, the change in temperature required to trigger a transition may further depend on the ambient relative humidity.

In some embodiments, a combination of a change in relative humidity and a change in temperature may be used to trigger a transition from CO₂ (or other gas) adsorption to CO₂ (or other gas) release by the paper-based sorbent.

Adsorption/desorption rates: In some embodiments, anion exchange resins and composite paper-based sorbents may be formulated to facilitate fast rates of gas adsorption and desorption. Faster rates of adsorption and desorption facilitate faster kinetics and more efficient transfer of gases (e.g., carbon dioxide) from dry environments to wet or humid environments. These faster rates facilitate performance of a greater number of humidity swing cycles per day, and require less anion exchange resin per system. These properties, which may include faster gas adsorption and desorption kinetics, thereby facilitating the use of greater number of gas exchange cycles per day, and the use of smaller quantities of resin, may support the design and development of smaller and more affordable gas transfer systems that might not otherwise be possible in the absence of the disclosed technologies.

In some cases, the potentially faster gas adsorption/desorption rates of the disclosed composite paper-based sorbents may result from improved equilibration rates when exposed to changes in humidity. As noted above, faster adsorption/desorption rates in response to environmental stimuli such as a change in temperature and/or humidity are advantageous in that they facilitate the use of faster cycle times and net CO₂ transfer rates. The paper-based sorbent sheet materials disclosed herein will likely equilibrate faster when exposed to changes in humidity as compared to, for example, a legacy polymer-based anion exchange material. In some embodiments the paper-based sorbent material may equilibrate at least 2×, at least 5×, at least 10×, at least 20×, at least 30×, or at least 40× as fast as a polymer-based anion exchange material, thereby resulting in correspondingly improved cycle times when deployed in a CO₂ extractor device.

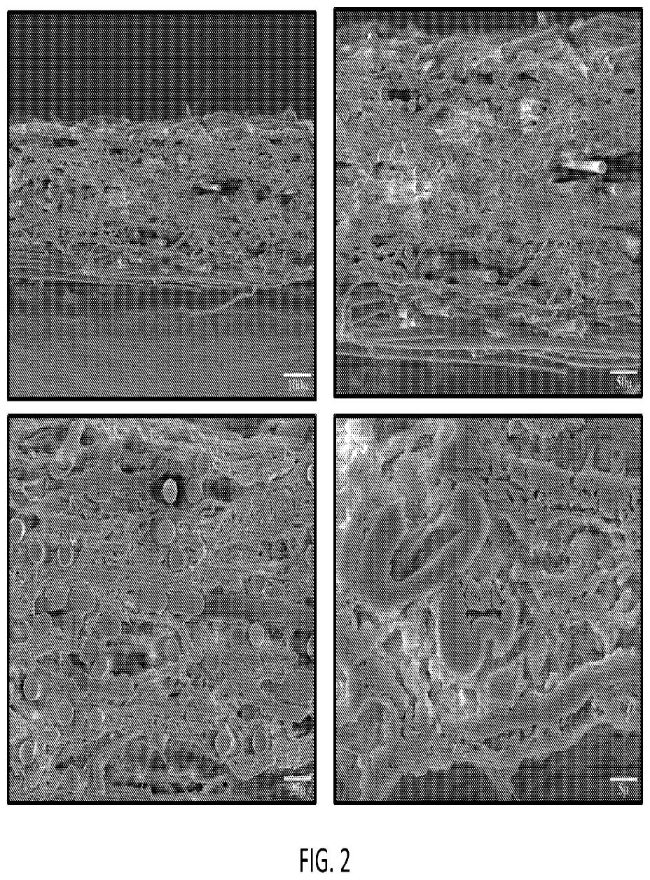

FIG. 2 provides non-limiting examples of scanning electron micrographs of a composite paper-based CO₂ capture material of the present disclosure comprising Purolite A500 (OH form) anion exchange resin. As can be seen, the resin particles are embedded within a porous matrix of fibers and other paper components, the porous nature of which ensures efficient contact of air (or other gas mixtures) with the resin particles.

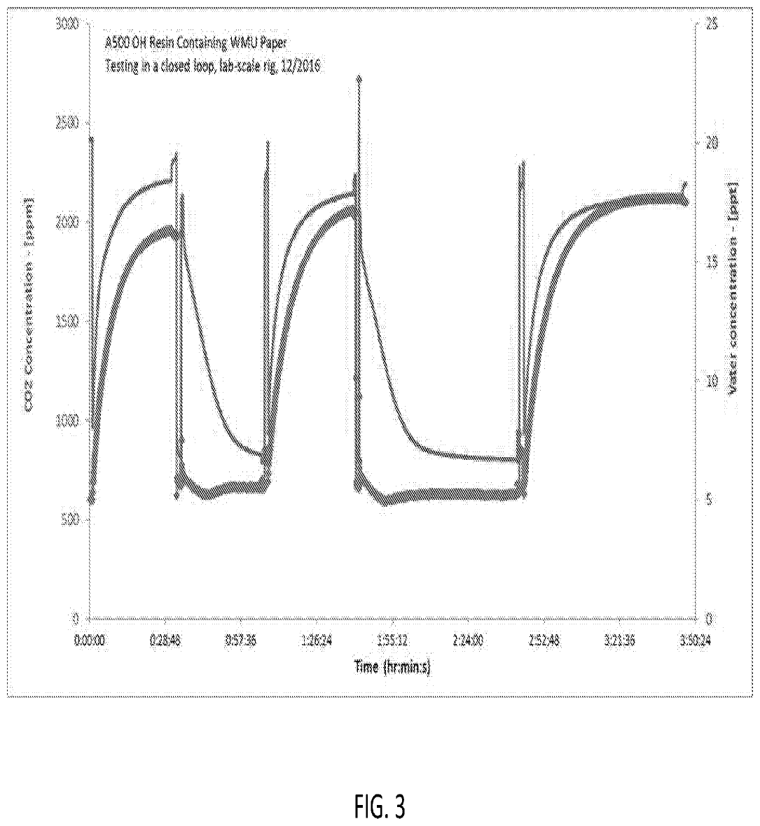

The disclosed paper-based sorbents comprise anion exchange resins and may be formulated such that the fraction of total binding sites occupied by carbon dioxide or other adsorbed gas molecules varies depending on the equilibrium partial pressure of the carbon dioxide or other gasses, as well as on other environmental factors such as relative humidity. FIG. 3 shows an example of data illustrating the relatively rapid uptake and release of CO₂ by a paper-based sorbent (comprising Purolite A500 anion exchange resin (i.e., the free OH form)) in response to changes in humidity. Tests were performed in a closed-loop, laboratory-scale environmental chamber (at ambient room temperature) in which CO₂ concentration could be monitored, and relative humidity (as measured by the water concentration in the air within the chamber) could be controlled. As can be see, changes in relative humidity resulted in corresponding changes in CO₂ concentration as CO₂ was adsorbed by the composite paper at low humidity, and released by the composite paper at high humidity.

Paper-based sorbent components: As noted above, the paper-based sorbents of the present disclosure will generally comprise one or more types of fiber, one or more types of resin for performing ion exchange, e.g., an anion exchange resin, and one or more types of additive.

Anion exchange resins: Anion exchange resin comprise a resin or polymer configured to act as a medium for anion exchange. The resin can be strongly or weakly basic. In instances where the resin is strongly basic, the resin may be configured to maintain a net positive charge when exposed to a broad range of pH values. In instances where the resin is weakly basic, the resin may not maintain a net positive charge at high pH, and may instead undergo deprotonation. Weakly basic resins offer mechanical and chemical stability that, combined with a high rate of anion exchange, make them well suited for applications such as removal of organic salts in water purification processes.

In general, ion exchange resins may require regeneration after a period of use in order to remove adsorbed ionic species and restore the active form of the functional chemical groups. For anion exchange resins, regeneration can involve treatment of the resin with a strongly basic solution (e.g., aqueous sodium hydroxide). During regeneration, the solution is passed through the resin, allowing trapped negative ions to be flushed out and thereby renewing the resin's ion exchange capacity. Formulations of the disclosed paper-based sorbents that are able to withstand repeated cycles of use and regeneration are therefore preferred.

Anion exchange resins can comprise materials produced by crosslinked polymers. Anion exchange resins can comprise strong base anion exchange resins. In some embodiments, strong base anion resins can include Type 1, Type 2, or a combination of Type 1 and Type 2 anion exchange resins. Type 1 strong base anion exchange resins comprise quaternized amine products made by the reaction of trimethylamine with a copolymer after chloromethylation. The Type 1 functional group is the most strongly basic functional group and thus exhibits the greatest affinity for weak acids, including silicic acid and carbonic acid, which may be present in, for example, water demineralization processes. The efficiency of regeneration of the resin to the hydroxide form may be lower than that for capture of weak acids, particularly when the resin is depleted of monovalent anions (e.g., chloride and nitrate). Type 2 resins may be produced by the reaction of a styrene-DVB copolymer with dimethylethanolamine. The quaternary amine typically has lower basicity than for Type 1 resin, and yet can remove weak acid anions in some applications. Typical examples of anion exchange resin often include copolymers made of styrene and divinyl benzene; styrene can be configured to act as the backbone or chain, and the divinylbenzene can act as the crosslinker as in, for example, Purolite A500 (macroporous polystyrene crosslinked with divinylbenzene), which is available in chloride and hydroxide forms. Purolite A500 is a strongly basic, Type I, macroporous anion exchange resin with an isoporous structure that contributes to its high ion exchange capacity. Purolite A500 can be configured to easily undergo deionization and function as an organic ion trap. The functional group is a type 1 quaternary ammonium salt. The amount of divinylbenzene crosslinker incorporated can be varied to produce resins with different physical strength, resistance to temperature and oxidative degradation, selectivity, and ion exchange capacity. Any of a variety of other commercially-available, strong base, type 1 anion exchange resins may also be utilized in the disclosed composite paper-based sorbents. In addition to the Purolite A500 resin noted above, examples include, but are not limited to, Dowex™ Marathon™ A (OH form), ResinTech SBMP1 (OH form), Rohm & Haas Amberlite IRA402 (OH form), and Rohm & Haas Amberlite 900 (OH form). In general, anion exchange resins should be converted to the OH form prior to use. Resins having a larger pore size may provide more efficient capture and release of CO₂.

In some embodiments, the paper-based sorbents of the present disclosure may comprise anion exchange resin particles having average diameters of less than 50 μm (e.g. less than 50 μm, less than 40 μm, less than 30 μm, less than 20 μm, less than 10 μm, less than 1 μm, less than 0.5 μm, less than 0.2 μm, or less than 0.1 μm). The anion exchange resin used in formulating the paper-based sorbents of the present disclosure may comprise particle over this size range without disrupting the structural integrity of the composite paper or inhibiting the humidity swing functionality. In cases where commercially-available anion exchange resins are used, the resin may be ground to produce finer particles of anion exchange material.

In some embodiments of the disclosed paper-based sorbents, the anion exchange resin loading factor (i.e., the weight of the resin included divided by the total weight for all composite paper components (or the % resin by weight)) may comprise greater than or equal to 20% resin, greater than or equal to 30% resin, greater than or equal to 40% resin, greater than or equal to 50% resin, greater than or equal to 60% resin, greater than or equal to 70% resin, or greater than or equal to 80% resin. The resin loading factor may have any value within the range of 20% resin to 80% resin, or more, for example, in some embodiments, the resin loading factor may be about 45%.

Fiber: The paper-based sorbent may comprise one or more forms or types of fiber, including natural fibers and/or synthetic fibers. Synthetic fibers can comprise any single type of fiber or a combination of fibers produced from chemical treatment or production methods. The fiber used may comprise any fiber or combination of fibers suitable for forming paper, and as noted may include synthetic fibers or natural fibers. Natural fibers may include any cellulosic fibrous material such as carbohydrate polymers (e.g., cellulose, hemicellulose). Natural fibers may include any fiber derived from wood, wheat, rice, reed, hemp, flax, cotton, bagasse, bamboo, grass, sorghum, kenaf, or a recovered or recycled fiber. Synthetic fibers are made synthetically from raw materials such as petroleum oil or synthetic, high-molecular weight organic compounds. Synthetic fibers may include any fiber comprising polyester, polyolefin (e.g., polypropylene or polyethylene), acrylic, aramid, 5d30, cyphrex, or vinylon. Natural and synthetic fibers may be used alone or in combination with one another to provide materials with the useful characteristics.

In some embodiments, the composite paper-based sorbents of the present disclosure may comprise from about 1% fiber (by weight) to about 99% fiber (by weight). In some embodiments, the fiber component may comprise at least 1%, at least 10%, at least 20%, at least 30%, at least 40%, at least 50%, at least 60%, at least 70%, at least 80%, at least 90%, or at least 99% by weight of the composite paper-based sorbent material. In some embodiments, the fiber component may comprise at most 99%, at most 90%, at most 80%, at most 70%, at most 60%, at most 50%, at most 40%, at most 30%, at most 20%, at most 10%, or at most 1% by weight of the composite paper-based sorbent. Those of skill in the art will recognize that the percentage of fiber in the composite paper-based sorbent may have any value within this range, e.g., 55%, that is compatible with providing the desired chemical, physical, and mechanical properties of the paper-based sorbent material.

Additives: To enhance desirable properties of paper during the papermaking process, chemicals can be added to the pulp slurry prior to sheet formation or to the resulting sheet after complete or partial drying. Paper additives can include process additives or functional additives. Process additives can comprise materials that improve the operation of the paper machine (e.g., retention and drainage aids, biocides, dispersants, and defoamers). Functional additives can comprise materials that enhance or alter specific properties of the paper product (e.g., fillers, sizing agents, wet- and dry-strength additives). Additives may be added on the wet end of processing, internally to the paper, and/or to the surface of the sheet. A paper-based sorbent can comprise one or more additives. Paper materials and paper-based sorbents can comprise additives for increasing the strength of the material. Additives can include binders and bonding agents such as a starch, for example, corn, tapioca, or potato starch, or a cationic starch. Additives can include thickening and stabilizing agents such as guar gum. Additives can include synthetic wet strength and dry strength aids such as acrylamide polymers and copolymers (e.g., polyacrylamide (PAM), glyoxalated polyacrylamide (GPAM), polyamide epichlorohydrin (PAE)), and polyvinyl alcohol.

In some embodiments, the amount of additive incorporated into the paper-based sorbent formulation may individually or collectively range from about 0% by weight to about 10% by weight. In some embodiments, the amount of a given additive, e.g., polyamide epichlorohydrin (PAE) or one or more of the other additives listed above, incorporated into the paper-based sorbent formulation may comprise at least 0% by weight, at least 0.2% by weight, at least 0.4% by weight, at least 0.6% by weight, at least 0.8% by weight, at least 1% by weight, at least 1.5% by weight, at least 2% by weight, at least 4% by weight, at least 6% by weight, at least 8% by weight, or at least 10% by weight. Those of skill in the art will recognize that the amount of a given additive, e.g., polyamide epichlorohydrin (PAE), that is incorporated into the paper-based sorbent formulation may have any value within this range, e.g., about 1.85% by weight.

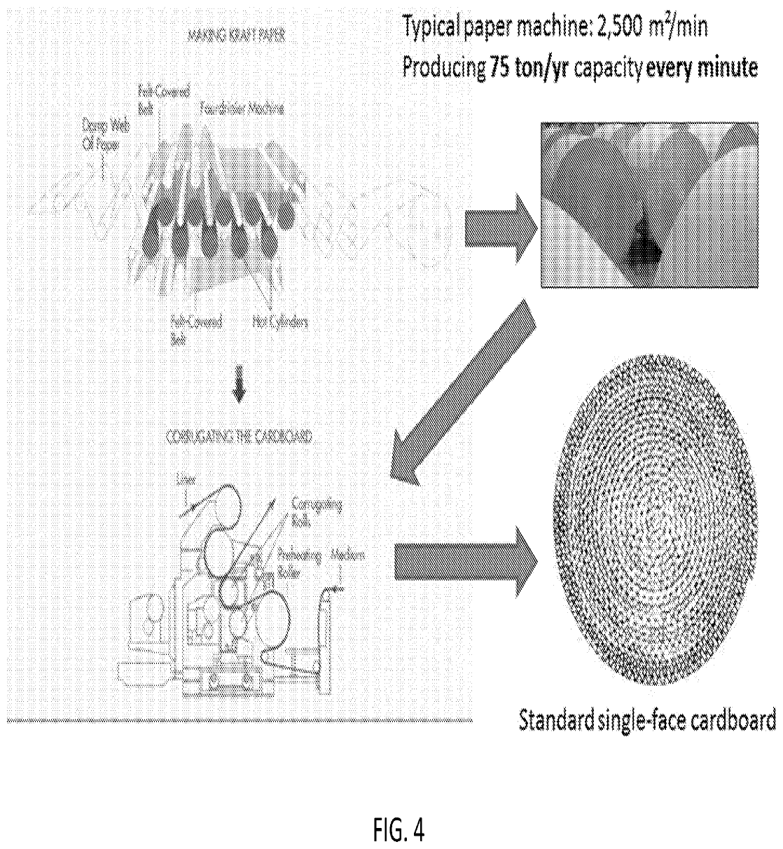

Paper-making processes: FIG. 4 illustrates a machine that can be used to generate corrugated paper-based sorbent sheets. The machine may comprise a Fourdrinier machine, where a headbox delivers a suspension of fibers (e.g., moist fibers of cellulose pulp derived from wood, rags or grasses), fillers, additives, and/or bonding agents onto a forming table where an interwoven web is formed, and the suspending water is subsequently drained from the web through a series of successive drainage elements. The web is further dewatered and bonded in a press section where water is removed via hydraulic pressure to form thin, flexible sheets. Final dryness is achieved via successive steam-heated cylinder drying until a final dryness of 2-6% by weight (i.e., percent weight of retained H₂O/total weight of sample) is achieved and the composite paper is formed into large rolls of dried paper-based sorbent sheet.

The pulp used in the paper-making process can be refined and mixed in water with other additives to make a pulp slurry that produces a paper sheet material having different chemical, physical, and/or mechanical properties. The head-box of the paper-making machine (e.g., a Fourdrinier machine, twin wire machine, top wire machine, gap former machine, dual Fourdrinier, machine, or cylinder machine) distributes the slurry onto a moving continuous screen, water is then drained from the slurry (by gravity or under vacuum), the wet paper sheet may be passed through presses and dried, and finally rolled into large rolls. The process may be scaled up to produce tons of material. Other types of paper machines can also be used. For example other machines may make use of a cylinder mold that rotates while partially immersed in a vat of dilute pulp. The pulp is picked up by the machine's forming wire and covers the mold as it rises out of the vat. A couch roller can then be pressed against the mold to smooth out the pulp, and pick the wet sheet off the mold.

In some embodiments, the thickness of the resulting paper-based sorbent sheet may range from about 75 μm to about 800 μm or greater. In some embodiments, the thickness of the paper-based sorbent sheet may be at least 75 μm, at least 100 μm, at least 150 μm, at least 200 μm, at least 250 μm, at least 300 μm, at least 350 μm, at least 400 μm, at least 450 μm, at least 500 μm, at least 550 μm, at least 600 μm, at least 650 μm, at least 700 μm, at least 750 μm, or at least 800 μm. In some embodiments, the thickness of the paper-based sorbent sheet may be at most 800 μm, at most 750 μm, at most 700 μm, at most 650 μm, at most 600 μm, at most 550 μm, at most 500 μm, at most 450 μm, at most 400 μm, at most 350 μm, at most 300 μm, at most 250 μm, at most 200 μm, at most 150 μm, at most 100 μm, or at most 75 μm. Those of skill in the art will recognize that the thickness of the paper-based sorbent sheet may have any value within this range, e.g., about 460 μm.

As noted above, fiber, resins, bonding agents and other additives can be combined to generate a paper material with particular physical, mechanical, and chemo-sorbent properties. For example, the paper can have a specified gram weight per square meter (or gsm). For example, the paper can have a gram weight per square meter of greater than 100 gsm, greater than 200 gsm, greater than 300 gsm, or greater than 400 gsm (e.g., the gram weight per square meter values may be calculated based on the final material selection (e.g., the fiber, resin, and additives combined). In some embodiments, as noted above, fiber can comprise a specified portion of the paper based sorbet, for example, less than or equal to 30%, less than or equal to 40%, less than or equal to 50%, less than or equal to 60%, less than or equal to 70%, less than or equal to 80%, less than or equal to 90% or less than or equal to 99.9% of the total mass of the paper based sorbent. Paper-based sorbents can comprise resins, e.g., anion exchange resins, for adsorbing carbon dioxide or other gasses. Under specified conditions, e.g., application of heat, application of water or other liquid, or application of humidity, the resins may release the adsorbed carbon dioxide or other gasses, thereby allowing the paper-based sorbent to be regenerated. As noted above, the amount of resin incorporated into the composite material used to create the composite paper-based sorbent may be varied, and may comprise greater than or equal to 0.1%, greater than or equal to 10%, greater than or equal to 20%, greater than or equal to 30%, greater than or equal to 40%, greater than or equal to 50%, greater than or equal to 60%, or greater than or equal to 70% by weight of the total mass of the paper-based sorbent. The upper limit for the percentage of resin incorporated into the composite material may be limited by the resulting wet strength and/or dry strength of the paper-based sorbent material and its compatibility with the paper-making and corrugation processes.

Formation of macrostructures: In some embodiments, the paper-based sorbent sheet materials may be further formed into macrostructures that facilitate gas contact with the anion exchange resin and/or the ability to package the sorbent in extractor devices in such a way as to maximize the surface area exposed to air or a gas mixture, while minimizing the overall volume of the device. Examples of such macrostructures include, but are not limited to, corrugated structures (e.g., cardboard-like structures), creped structures, embossed structures, folded structures, rolled structures (e.g., tubes, hollow cylinders, spiral wound rolls of corrugated sheet material), etc. In some instances, the paper-based sorbents may be formulated to be chemically and/or physically robust, such that they are able to withstand elution and washing processes, repeated cycles of swelling/shrinking of the resin particles, and corrugation or other macrostructure forming processes. In some instances, paper-based sorbents of the present disclosure may be formulated such that they are compatible with mass production of sheet materials and/or bending, folding, laminating, creping, embossing, or corrugation processes.

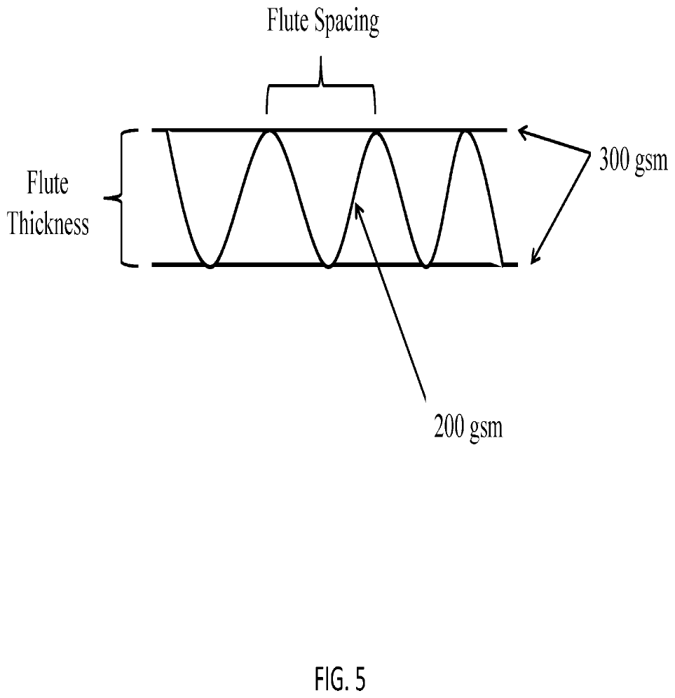

As illustrated in FIG. 4, rolls of paper-based sorbent or other medium can be fed into a corrugation machine configured for corrugating any of a variety of media. The paper-based sorbent sheet can be fed into the corrugating machine using a series of carrying rollers to establish tension control, web flatness, and temperature until it comes into contact with the corrugating roller, which is machined in a “U” or “V” pattern for creating the corrugation. The corrugating rollers can be disposed such that the paper-based sorbent moves from a smooth preheating roller configured to heat the paper-based sorbent prior to making contact with a first corrugating cylinder and then a second corrugating cylinder, which together corrugate the paper-based sorbent by applying force on the heated sorbent sheet material and deforming the sheet material between the teeth of the two corrugating rollers. After the corrugating cylinders corrugate the paper-based sorbent (e.g. into standard single-face cardboard), the corrugated paper-based sorbent is transferred out of the machine as a flat sheet of corrugated board. In some embodiments, the corrugated sheet may be adhered to a face sheet using an adhesive to bond the peaks of the corrugated medium to the face sheet. The latter may comprise single-faced corrugated sheets, double-faced corrugated sheets, etc. In some embodiments, the corrugation pattern (e.g., “U”, “V”, sinusoidal patterns, or other pattern), the dimensions of the corrugation flutes (i.e., the peak-to-peak thickness and/or spacing; see FIG. 5), and/or the weight of the sheet materials used may vary in different layers of a multi-layered corrugated paper-based sorbent sheet. In general, the flute thickness may range from about 0.5 mm to about 5 mm, and in specific embodiments may have any value within this range, e.g., about 3.2 mm. In general, the flute spacing may be such that the number of flutes per unit distance ranges from about 50 flutes/meter to about 450 flutes/meter, and in specific embodiments may have any value within this range, e.g., about 150 flutes/meter. In some embodiments, the corrugated sheets may be formed into multi-layered constructs (e.g., multi-layered stacks or spiral-wound rolls) to configure the anion exchange media for specific CO₂ extractor device designs.

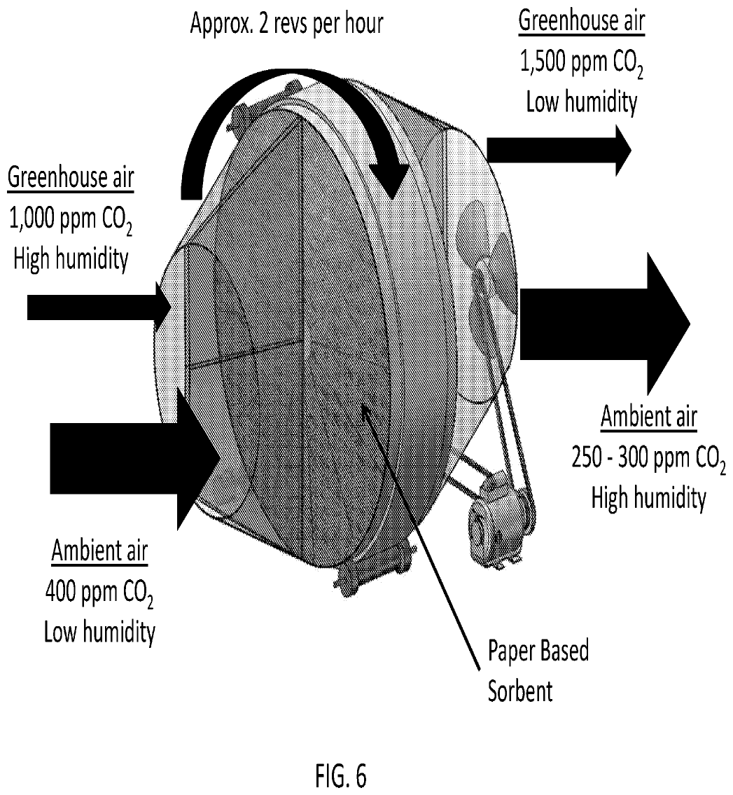

Extractor devices comprising paper-based sorbents: FIG. 6 illustrates an exemplary application of the disclosed corrugated paper-based sorbent for enriching the carbon dioxide levels and adjusting humidity in a greenhouse. As shown here, the paper-based sorbent may be configured in a spiral-wound, circular shape suitable for use in a rotating CO₂ capture and release device, for example a device that collects low humidity ambient air (e.g., comprising ˜400 ppm carbon dioxide) and high humidity greenhouse air and directs each through a different portion of the rotating circular disk of paper-based sorbent, thereby increasing the humidity of, and decreasing the carbon dioxide content of the ambient air passing through the device, while simultaneously decreasing the humidity of, and enriching the carbon dioxide content of the greenhouse air passing through the device (e.g., up to about 1,500 ppm within the greenhouse). The net effect is thus to transfer CO₂ from ambient (outdoor) air to the interior of the greenhouse, while taking advantage of the generally higher humidity of the greenhouse interior to trigger the release of adsorbed CO₂ from the paper-based sorbent. The overall transfer rates that may be achieved will vary with the design details of the apparatus, e.g., the gas exchange properties of the paper-based sorbent used to fabricate the rotating wheel, the diameter and thickness of the rotating wheel, the rotation rate of the rotating wheel, the difference in relative humidity (and temperature) between the ambient air and the greenhouse interior, the flow rate of ambient air and greenhouse air through the device, etc.

In some embodiments, the CO₂ concentration of ambient air from which the extractor device captures CO₂ may range from about 300 ppm to about 500 ppm. In some embodiments, the CO₂ concentration of the ambient air may be at least 300 ppm, at least 350 ppm, at least 375 ppm, at least 400 ppm, at least 425 ppm, at least 450 ppm, or at least 500 ppm. In some embodiments, the CO₂ concentration of the ambient air may be at most 500 ppm, at most 450 ppm, at most 425 ppm, at most 400 ppm, at most 375 ppm, at most 350 ppm, or at most 300 ppm. Those of skill in the art will recognize that the CO₂ concentration of ambient air may have any value within this range, e.g., about 395 ppm.

In some embodiments, the resulting CO₂ concentration of the air inside of the greenhouse (or other structure), i.e., the “indoor” air, may range from about 500 ppm to about 2,500 ppm, or higher. In some embodiments, the resulting CO₂ concentration of the greenhouse air (or indoor air) may be at least 500 ppm, at least 600 ppm, at least 700 ppm, at least 800 ppm, at least 900 ppm, at least 1,000 ppm, at least 1,100 ppm, at least 1,200 ppm, at least 1,300 ppm, at least 1,400 ppm, at least 1,500 ppm, at least 2,000 ppm, at least 2,500 ppm, at least 3,000 ppm, or at least 4,000 ppm. In some embodiments, the resulting CO₂ concentration of the greenhouse air (or indoor air) may be at most 4,000 ppm, at most 3,000 ppm, at most 2,500 ppm, at most 2,000 ppm, at most 1,500 ppm, at most 1,400 ppm, at most 1,300 ppm, at most 1,200 ppm, at most 1,100 ppm, at most 1,000 ppm, at most 900 ppm, at most 800 ppm, at most 700 ppm, at most 600 ppm, or at most 500 ppm. Those of skill in the art will recognize that the CO₂ concentration of the greenhouse air (or indoor air) may have any value within this range, e.g., about 1,050 ppm.

In some embodiments, as noted above, the paper-based sorbents of the present disclosure may be corrugated and rolled into spiral wound rolls for use in a wheel-type rotary extraction device. In these embodiments, the performance of the extraction device may vary with design features of the device as well as with the performance characteristics of the paper-based sorbent. For example, the performance of the extraction device may vary with the diameter of the rotating sorbent wheel, the thickness of the rotating sorbent wheel, the rotation rate of the rotating sorbent wheel, and/or the volumetric flow rate of air passing through the device (i.e., of ambient air flowing into the greenhouse and greenhouse air flowing out of the greenhouse).

In some embodiments, the diameter of the rotating wheel comprising the spiral-wound roll of corrugated, paper-based sorbent (i.e., the sorbent wheel) may range from about 0.1 meters to about 2 meters. In some embodiments, the diameter of the rotating sorbent wheel may be at least 0.1 meters, at least 0.2 meters, at least 0.3 meters, at least 0.4 meters, at least 0.5 meters, at least 0.75 meters, at least 1 meter, at least 1.25 meters, at least 1.5 meters, at least 1.75 meters, or at least 2 meters. In some embodiments, the diameter of the rotating sorbent wheel may be at most 2 meters, at most 1.75 meters, at most 1.5 meters, at most 1.25 meters, at most 1 meter, at most 0.75 meters, at most 0.5 meters, at most 0.4 meters, at most 0.3 meters, at most 0.2 meters, or at most 0.1 meters. Those of skill in the art will recognize that the diameter of the rotating sorbent wheel may have any value within this range, e.g., about 1.1 meters.

In some embodiments, the thickness of the rotating sorbent wheel may range from about 0.1 meters to about 1 meter. In some embodiments, the thickness of the rotating sorbent wheel may be at least at least 0.1 meters, at least 0.2 meters, at least 0.3 meters, at least 0.4 meters, at least 0.5 meters, at least 0.6 meters, at least 0.7 meters, at least 0.8 meters, at least 0.9 meters, or at least 1 meter. In some embodiments, the thickness of the rotating sorbent wheel may be at most 1 meter, at most 0.9 meters, at most 0.8 meters, at most 0.7 meters, at most 0.6 meters, at most 0.5 meters, at most 0.4 meters, at most 0.3 meters, at most 0.2 meters, or at most 0.1 meters. Those of skill in the art will recognize that the thickness of the rotating sorbent wheel may have any value within this range, e.g., about 0.55 meters.

In some embodiments, the rotation rate of the rotating sorbent wheel may range from about 0.1 rpm to about 10 rpm, or higher. In some embodiments, the rotation rate of the rotating sorbent wheel may be at least 0.1 rpm, at least 0.25 rpm, at least 0.5 rpm, at least 0.75 rpm, at least 1 rpm, at least 2 rpm, at least 3 rpm, at least 4 rpm, at least 5 rpm, at least 6 rpm, at least 7 rpm, at least 8 rpm, at least 9 rpm, at least 10 rpm, at least 25 rpm, or at least 50 rpm. In some embodiments, the rotation rate of the rotating sorbent when may be at most 50 rpm, at most 25 rpm, at most 10 rpm, at most 9 rpm, at most 8 rpm, at most 7 rpm, at most 6 rpm, at most 5 rpm, at most 4 rpm, at most 3 rpm, at most 2 rpm, or at most 1 rpm. Those of skill in the art will recognize that the rotation rate of the rotating sorbent wheel may have any value within this range, e.g., about 1.3 rpm.

In some embodiments, the volumetric flow rate of air flowing through the rotating sorbent wheel (i.e., ambient air flowing into the greenhouse, or greenhouse air flowing out of the greenhouse) may range from about 0.1 cubic meters per minute to about 10 cubic meters per minute, or higher. In some embodiments, the volumetric flow rate of air may be at least 0.1 cubic meters per minute, at least 0.25 cubic meters per minute, at least 0.5 cubic meters per minute, at least 0.75 cubic meters per minute, at least 1 cubic meter per minute, at least 2 cubic meters per minute, at least 3 cubic meters per minute, at least 4 cubic meters per minute, at least 5 cubic meters per minute, at least 6 cubic meters per minute, at least 7 cubic meters per minute, at least 8 cubic meters per minute, at least 9 cubic meters per minute, or at least 10 cubic meters per minute. In some embodiments, the volumetric flow rate of air may be at most 10 cubic meters per minute, at most 9 cubic meters per minute, at most 8 cubic meters per minute, at most 7 cubic meters per minute, at most 6 cubic meters per minute, at most 5 cubic meters per minute, at most 4 cubic meters per minute, at most 3 cubic meters per minute, at most 2 cubic meters per minute, at most 1 cubic meters per minute, at most 0.75 cubic meters per minute, at most 0.5 cubic meters per minute, at most 0.25 cubic meters per minute, or at most 0.1 cubic meters per minute.

In some embodiments, a combination of sensors, e.g., CO₂ sensors and/or humidity sensors, and feedback circuitry may be used to monitor and control the CO₂ concentration and/or humidity of the air inside the greenhouse by varying, for example, the rotation rate and/or volumetric flow rate of air through the rotating sorbent wheel. In some embodiments, the CO₂ content of the greenhouse air may therefore be maintained within a specified range of a desired target level for all or a portion of the day/night cycle. For example, in some embodiments, the CO₂ content of the greenhouse air may be maintained within a coefficient of variation of ±5%, ±10%, ±15%, or ±20% of the target CO₂ level. In some embodiments, the relative humidity of the greenhouse air may also be maintained within a specified range of a desired target level for all or a portion of the day/night cycle. For example, in some embodiments, the relative humidity of the greenhouse air may be maintained within a coefficient of variation of ±5%, ±10%, ±15%, or ±20% of the target relative humidity level.

Mechanical properties of paper-based sorbents: The physical and mechanical properties of the paper-based sorbent may be characterized using a number of measurement techniques. For example, tensile energy absorption (TEA) is the work done when a specimen is stressed to rupture in tension under prescribed conditions as measured by the integral of the tensile strength over the range of tensile strain from zero to maximum strain. The TEA can be expressed as energy required per unit area (test span×width) of the test specimen. In general, a higher TEA value is favored for papers or paper-based sorbents intended for use in, for example, a corrugation process, as it indicates that a given formulation of paper or paper-based sorbent will be able to absorb more energy without rupturing, and thus indicates how durable the paper or paper-based sorbent will be when subjected to repetitive or dynamic stresses or strains.

In general, the dry TEA values for the disclosed paper-based sorbents may range from about 30 to about 110 J/m². In some embodiments, the dry TEA may be at least 30, at least 40, at least 50, at least 60, at least 70, at least 80, at least 90, at least 100, or at least 110 J/m². In some embodiments, the dry TEA value for the disclosed paper-based sorbents may be at most 110, at most 100, at most 90, at most 80, at most 70, at most 60, at most 50, at most 40, or at most 30 J/m².

In general, the wet TEA values for the disclosed paper-based sorbents may range from about 0.3 to about 4.5 J/m². In some embodiments, the wet TEA may be at least 0.3, at least 0.5, at least 1.0, at least 1.5, at least 2.0, at least 2.5, at least 3.0, at least 3.5, at least 4.0, or at least 4.5 J/m². In some embodiments, the wet TEA value for the disclosed paper-based sorbents may be at most 4.5, at most 4.0, at most 3.5, at most 3.0, at most 2.5, at most 2.0, at most 1.5, at most 1.0, at most 0.5, or at most 0.3 J/m².

Tensile index is the tensile strength in N/m divided by gram weight. Tensile index can be measured for the dry paper based sorbent (dry tensile index) or for the wet paper based sorbent (wet tensile index). In general, a higher tensile index value is favored for papers or paper-based sorbents intended for use in, for example, a corrugation process, as it indicates that a given formulation of paper or paper-based sorbent will be able to withstand a greater force per unit width per unit weight prior to rupture.

In general, the dry tensile index values for the disclosed paper-based sorbents may range from about 3 to about 12 Nm/g. In some embodiments, the dry tensile index may be at least 3, at least 4, at least 5, at least 6, at least 7, at least 8, at least 9, at least 10, at least 11, or at least 12 Nm/g. In some embodiments, the dry tensile index value for the disclosed paper-based sorbents may be at most 12, at most 11, at most 10, at most 9, at most 8, at most 7, at most 6, at most 5, at most 4, or at most 3 Nm/g.

In general, the wet tensile index values for the disclosed paper-based sorbents may range from about 0.05 to about 0.8 Nm/g. In some embodiments, the wet tensile index may be at least 0.05, at least 0.1, at least 0.2, at least 0.3, at least 0.4, at least 0.5, at least 0.6, at least 0.7, or at least 0.8 Nm/g. In some embodiments, the wet tensile index value for the disclosed paper-based sorbents may be at most 0.8, at most 0.7, at most 0.6, at most 0.5, at most 0.4, at most 0.3, at most 0.2, at most 0.1, or at most 0.05 Nm/g.

Gurley porosity, also referred to as the Gurley second or Gurley unit, is a unit describing the number of seconds required for 100 cubic centimeters (1 deciliter) of air to pass through 1.0 square inch of a given material at a pressure differential of 4.88 inches of water. In general, a lower value of Gurley porosity is favored for the disclosed paper-based sorbents, as a lower value is indicative of a lower overall resistance to air or gas flow, and favorable conditions for gas exchange.

Elongation measures the percentage change in length before fracture of a specimen. It can be measured as the increase in gage length (measured after rupture) divided by original gage length. Higher elongation indicates higher ductility. Elongation cannot be used to predict behavior of materials subjected to sudden or repeated loading. Elongation can also be measured on dry paper based sorbent or wet paper based sorbent.

The tearing index is obtained by dividing the tearing resistance by the sample grammage or basis weight. For paper or paper-based sorbent specimens held between the two holders that apply a uniform pulling force, a cut in along the machine axis is to perform a machine direction tear test, and a cut in the cross direction is used to perform a cross direction test.

### Example 1—Characterization of Physical and Mechanical Properties of Paper-Based Sorbent Formulations

Preliminary studies were conducted to characterize the material properties for several different paper based sorbent formulations. The objective was to produce sheet materials that contain up to 50% anion exchange resin by weight, and that exhibit material properties conducive to producing a paper-based sorbent capable of being corrugated. In this particular study, the formulation comprising about 27% to 33% by weight of cotton, about 27% to 33% by weight of 1.5 poly (Barnet GmbH), and about 1.1-1.32 wt % of polyamide epichlorohydrin (PAE) (a strength additive; i.e., 2 g PAE in samples comprising 150 g to 180 g total of fiber and resin) appeared to provide the best material properties.

Table 1 summarizes the compositions of the paper-based sorbent formulations used in the study. The various components of each sample are indicated in units of parts per sample. Cotton was refined in a valley beater for 25 mins, CSF=190. Paper-based sorbent sheets were produced using the methods described in Example 2.

TABLE 1
Sample Formulations

| Sample | Fiber | Cotton | 1.5 Poly | 5d30 | Cyphrex | PAE | Resin Size | Resin | Resin |
|---|---|---|---|---|---|---|---|---|---|
| ID | (gsm) | (g) | (g) | (g) | (g) | (g) | (um, median) | (g) | (weight %) |
| 1 | 400 | 50 | 50 | | | 0 | 11 | 50 | 33 |
| 2 | 400 | 50 | | 50 | | 0 | 11 | 50 | 33 |
| 3 | 400 | 50 | | | 50 | 0 | 11 | 50 | 33 |
| 4 | 400 | 50 | | 50 | | 2 | 11 | 30 | 23 |
| 5 | 400 | 50 | | | 50 | 2 | 11 | 30 | 23 |
| 6 | 400 | 50 | 50 | | | 2 | 11 | 50 | 33 |
| 7 | 400 | 50 | 50 | | | 2 | 11 | 60 | 37 |
| 8 | 400 | 50 | 50 | | | 2 | 11 | 70 | 41 |
| 9 | 400 | 50 | 50 | | | 2 | 11 | 80 | 44 |

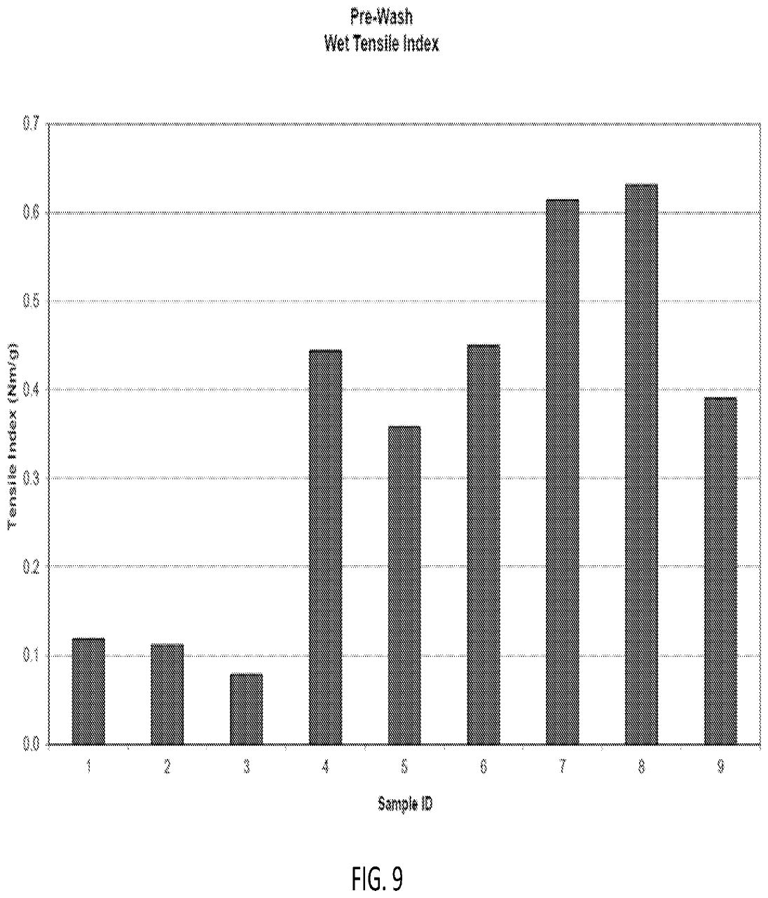

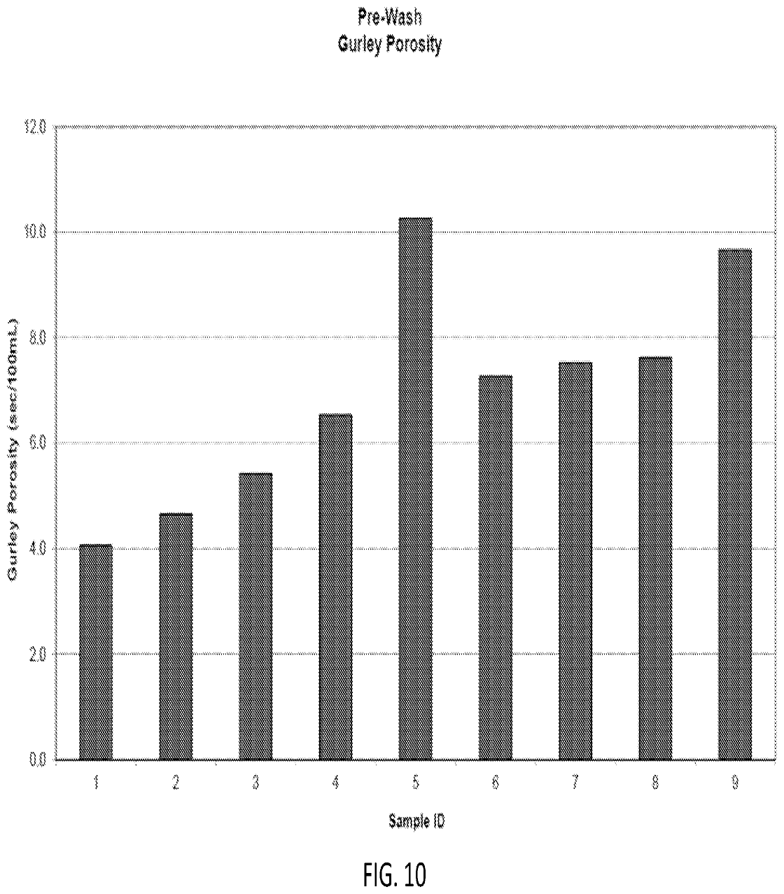

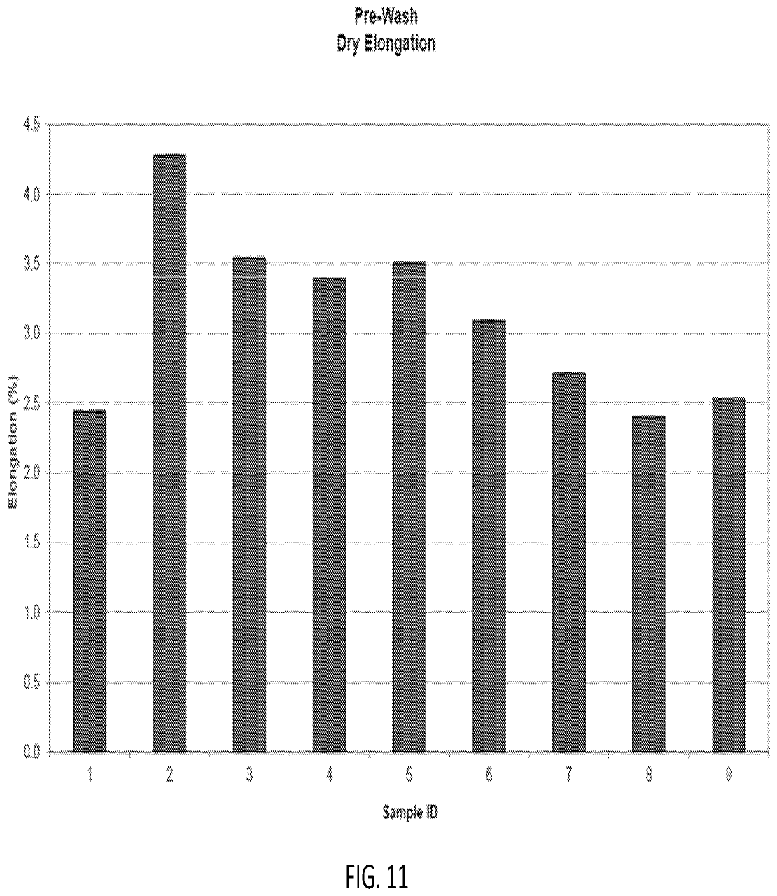

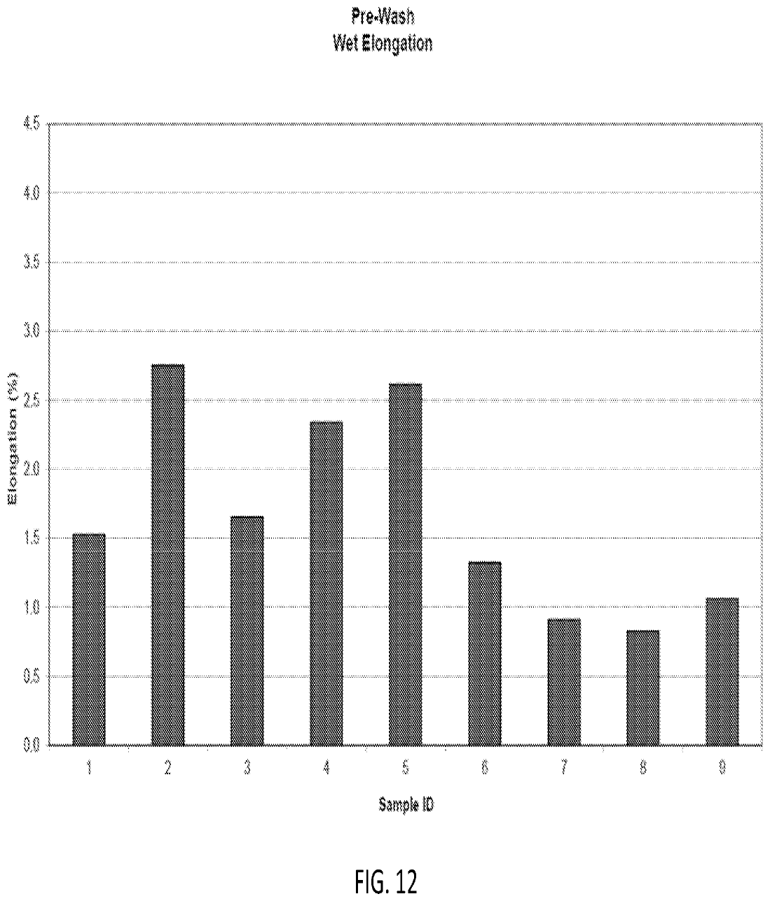

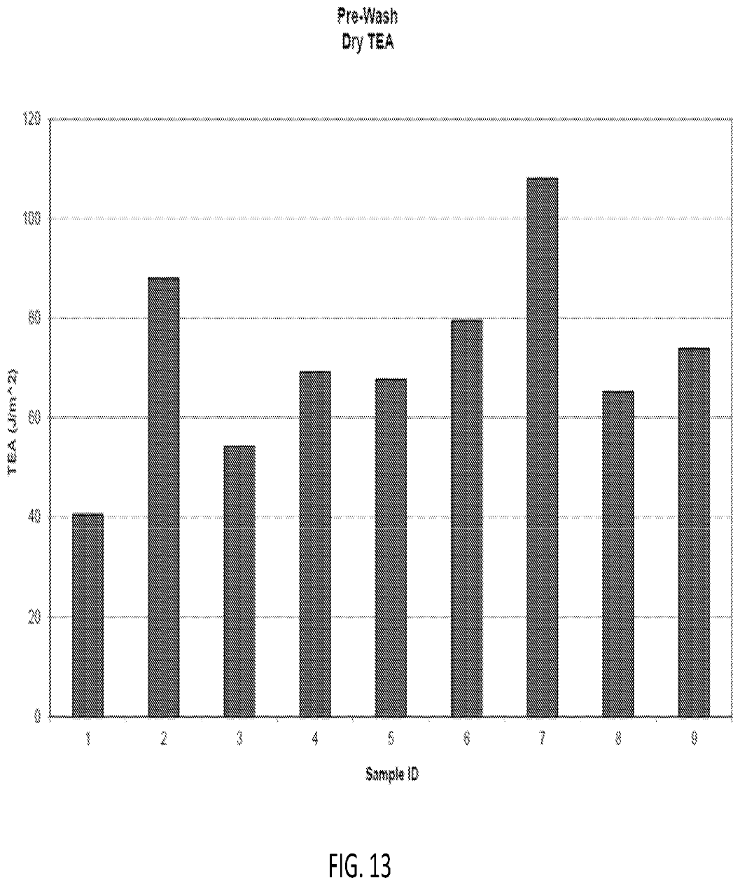

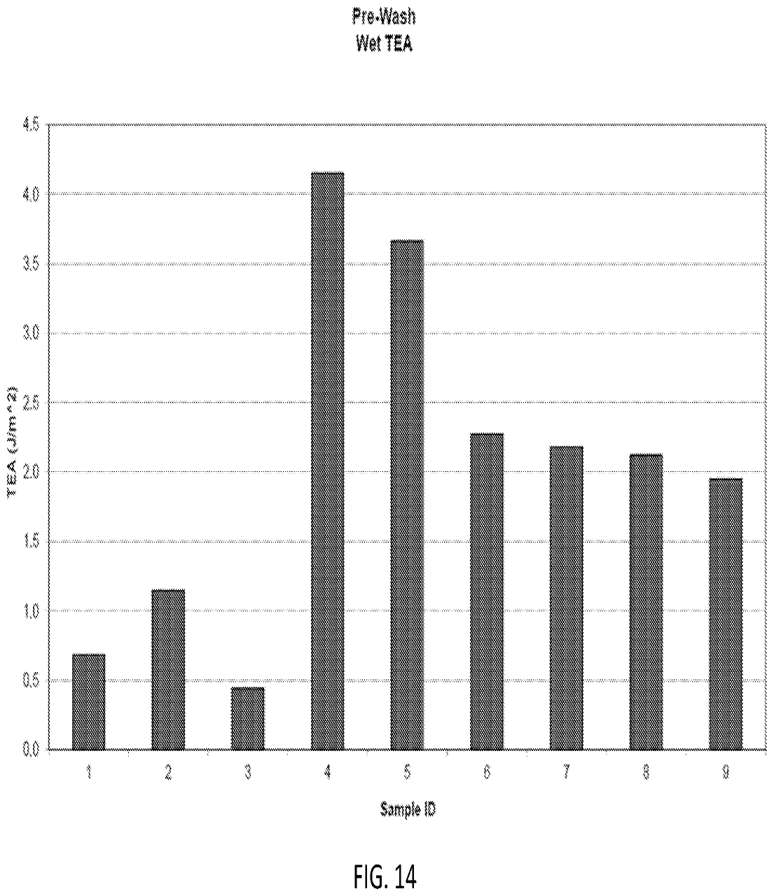

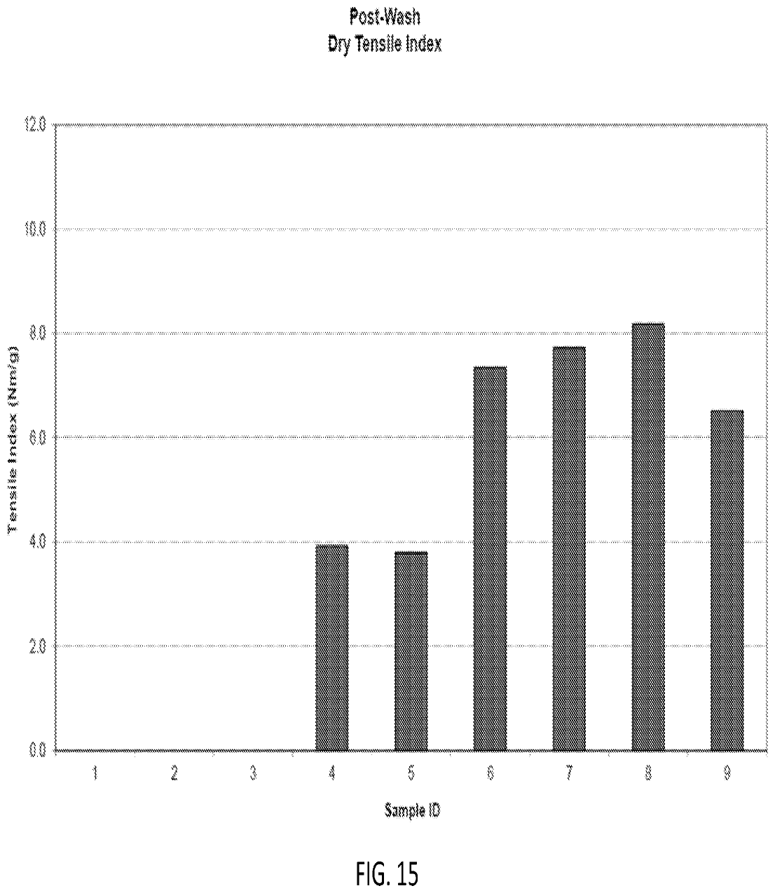

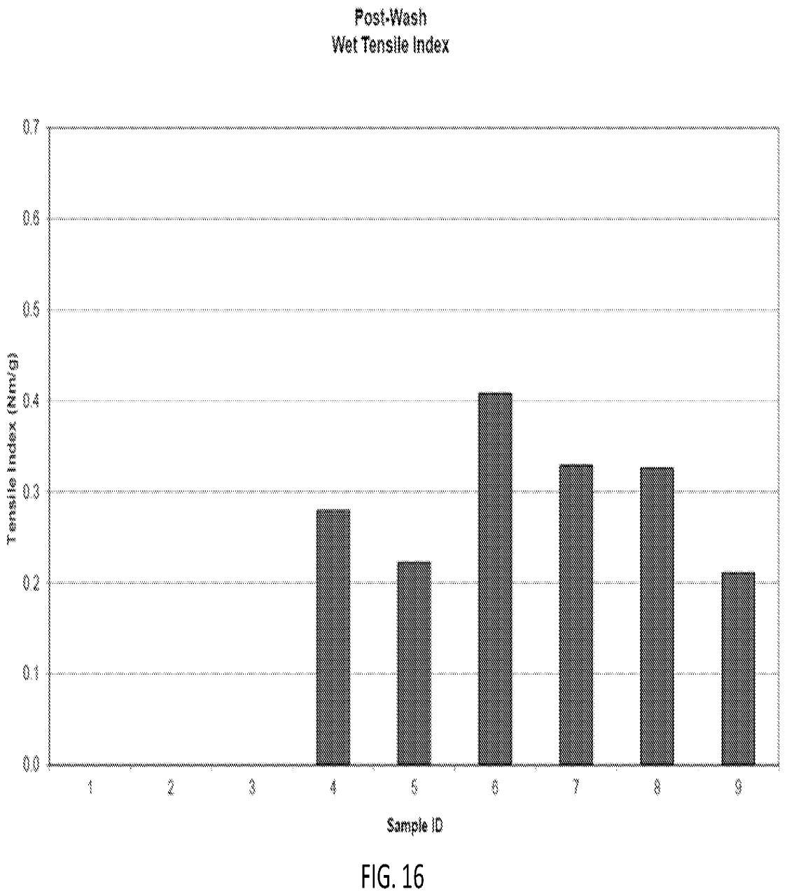

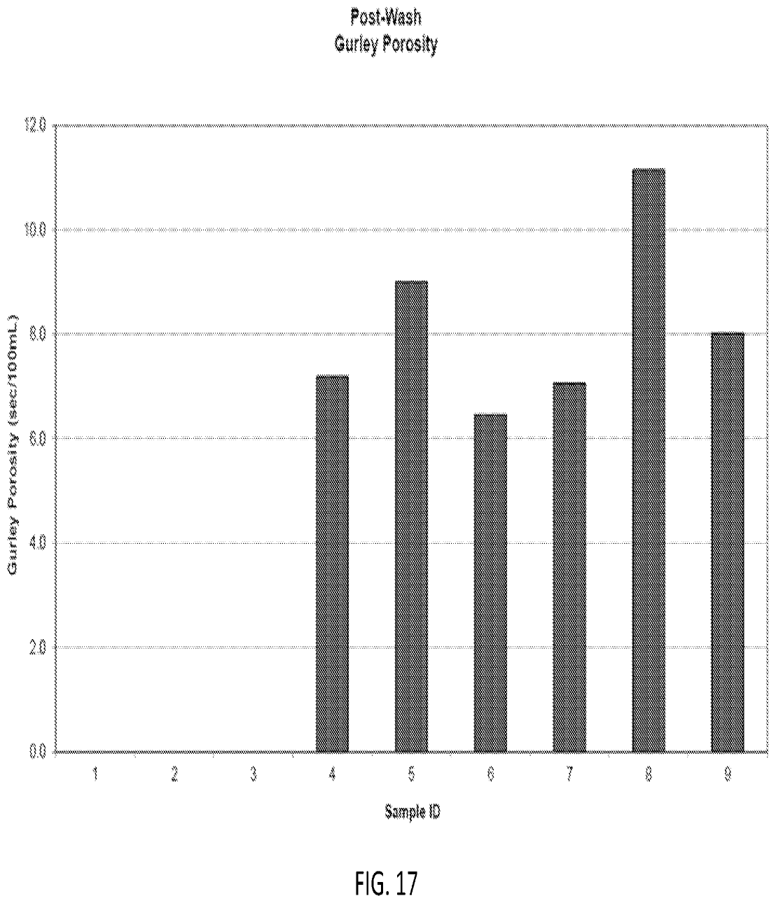

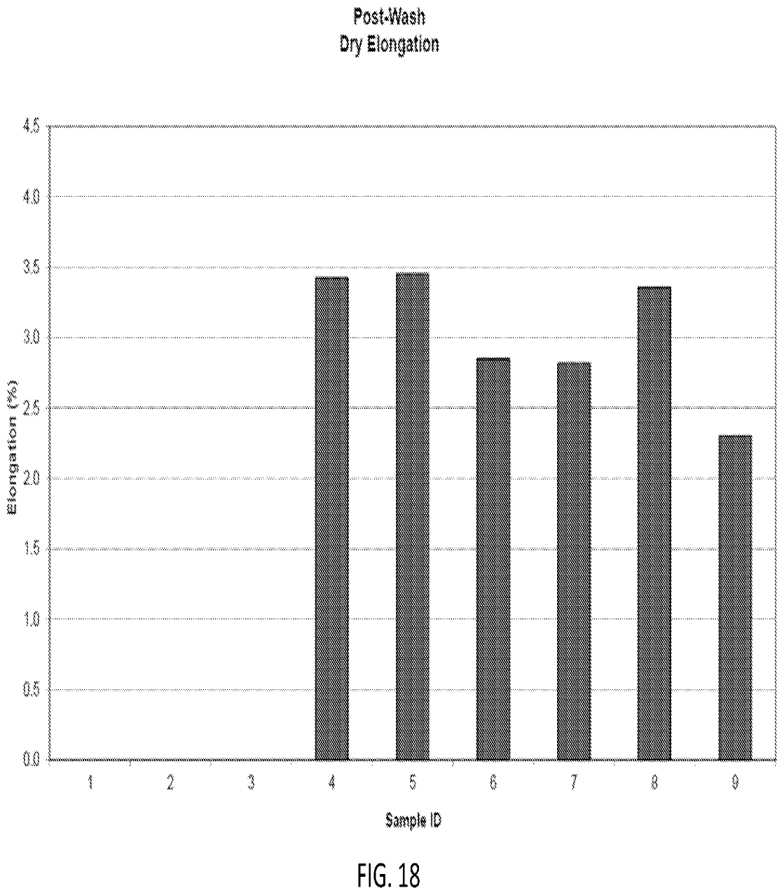

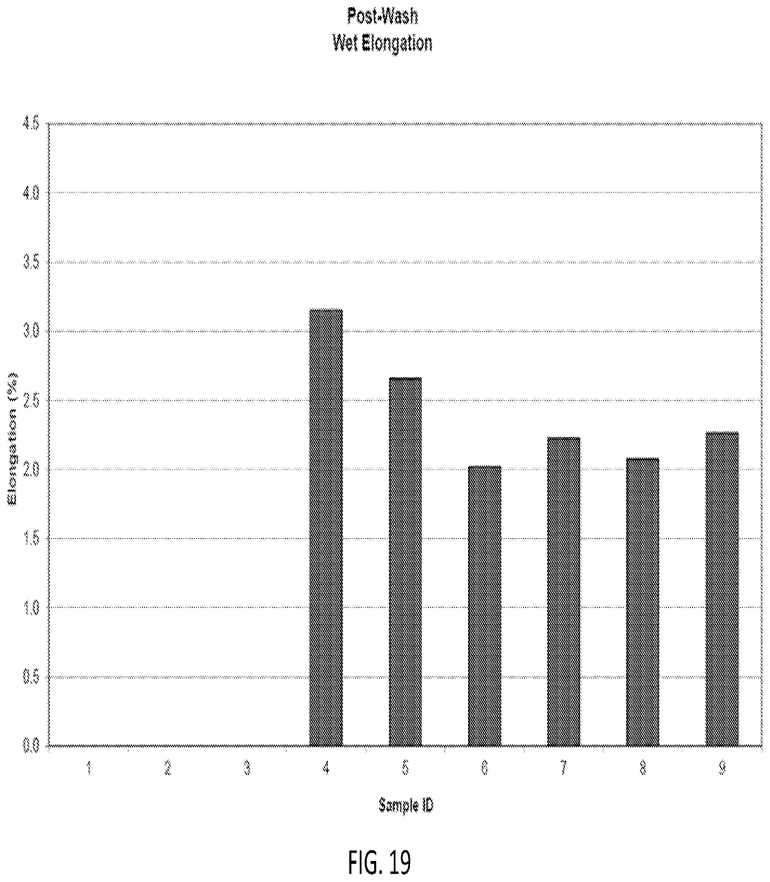

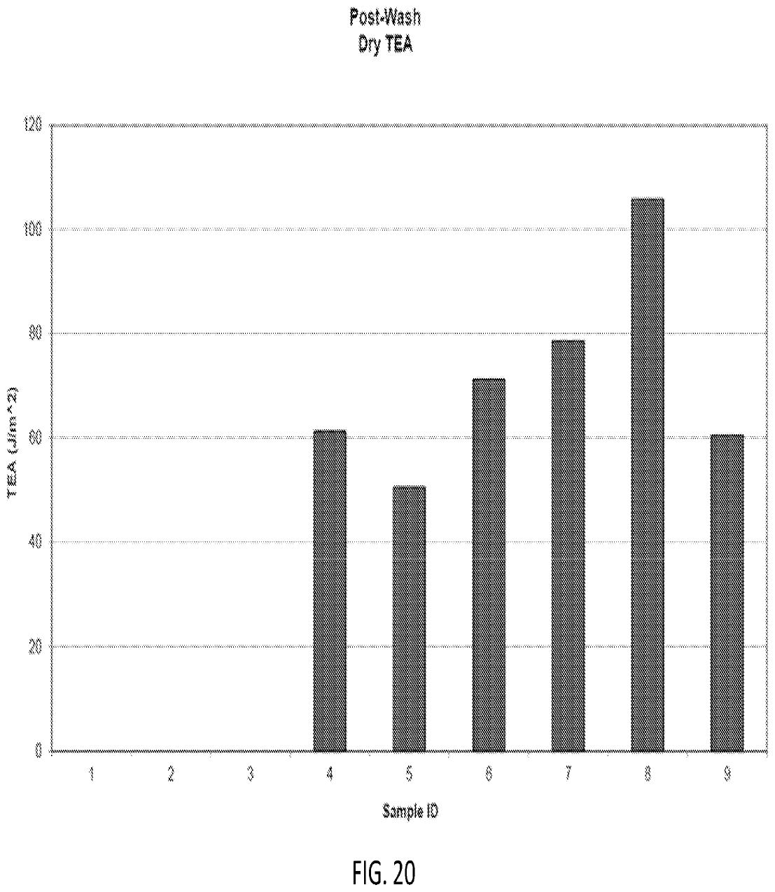

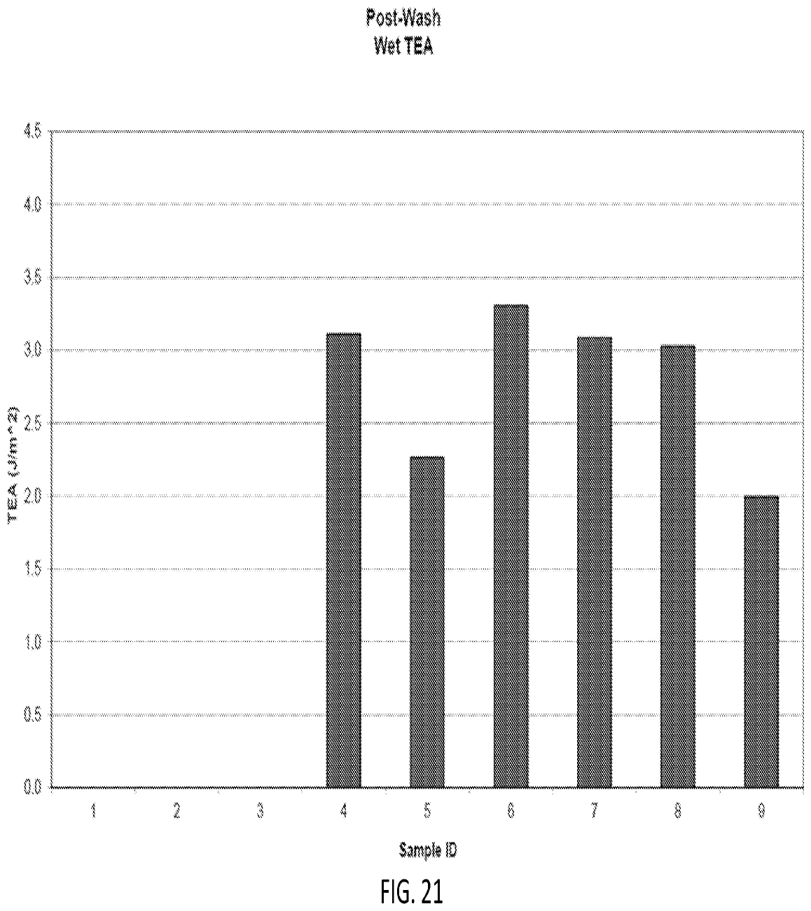

Tables 2 and 3 (and FIGS. 9-23) summarize test data for the nine samples listed in Table 1 before and after the samples were subjected to a caustic wash (samples were subjected to a 1M NaOH caustic wash for 24 hours, followed by rinsing with water for 1 minute, and then allowed to dry 48 hours). The data listed in Tables 2 and 3 include the measured values for dry tensile index, wet tensile index, Gurley porosity, dry elongation, wet elongation, dry tensile energy absorption (dry TEA) and wet tensile energy absorption (wet TEA). OOR=out of range.

TABLE 2
Pre Caustic Wash

| | Tearing Index | | Dry Tensile Index | | Wet Tensile Index | | Gurley Porosity | |
|---|---|---|---|---|---|---|---|---|
| Sample | mNm\hat{ }2/g | | Nm/g | | Nm/g | | sec/100 mL | |
| ID | Average | S.D. | Average | S.D. | Average | S.D. | Average | S.D. |
| 1 | OOR | — | 5.204 | 1.093 | 0.119 | 0.034 | 4.1 | 3.6 |
| 2 | 11 | 1 | 6.014 | 0.798 | 0.112 | 0.020 | 4.7 | 1.2 |
| 3 | 6 | 0 | 4.376 | 0.347 | 0.079 | 0.009 | 5.4 | 0.8 |
| 4 | 9 | 1 | 4.941 | 0.809 | 0.444 | 0.066 | 6.5 | 0.6 |
| 5 | 6 | 1 | 5.016 | 0.452 | 0.358 | 0.038 | 10.3 | 1.9 |
| 6 | OOR | — | 7.306 | 1.356 | 0.450 | 0.071 | 7.3 | 0.6 |
| 7 | OOR | — | 9.972 | 0.998 | 0.614 | 0.092 | 7.5 | 0.9 |
| 8 | OOR | — | 7.199 | 2.444 | 0.631 | 0.107 | 7.6 | 0.8 |
| 9 | OOR | — | 6.985 | 1.471 | 0.390 | 0.091 | 9.7 | 1.0 |

| | Dry Elongation | | Wet Elongation | | Dry TEA | | Wet TEA | |
|---|---|---|---|---|---|---|---|---|
| Sample | % | | % | | J/m\hat{ }2 | | J/m\hat{ }2 | |
| ID | Average | S.D. | Average | S.D. | Average | S.D. | Average | S.D. |
| 1 | 2.440 | 0.225 | 1.527 | 0.593 | 40.581 | 12.648 | 0.682 | 0.309 |
| 2 | 4.277 | 0.589 | 2.753 | 0.516 | 88.051 | 17.818 | 1.148 | 0.467 |
| 3 | 3.542 | 0.417 | 1.651 | 0.393 | 54.296 | 11.383 | 0.442 | 0.172 |
| 4 | 3.397 | 0.645 | 2.337 | 0.901 | 69.252 | 26.768 | 4.153 | 2.210 |
| 5 | 3.506 | 0.308 | 2.613 | 0.544 | 67.656 | 7.054 | 3.664 | 1.116 |
| 6 | 3.094 | 0.461 | 1.320 | 0.348 | 79.522 | 19.603 | 2.273 | 0.679 |
| 7 | 2.716 | 0.460 | 0.910 | 0.230 | 108.058 | 28.281 | 2.181 | 0.637 |
| 8 | 2.401 | 0.572 | 0.825 | 0.215 | 65.184 | 34.804 | 2.121 | 0.763 |
| 9 | 2.531 | 0.424 | 1.061 | 0.494 | 73.926 | 22.139 | 1.947 | 0.954 |

TABLE 3
Post Caustic Wash

| | Dry Tensile Index | | Wet Tensile Index | | Gurley Porosity | |
|---|---|---|---|---|---|---|
| Sample | Nm/g | | Nm/g | | sec/100 mL | |
| ID | Average | S.D. | Average | S.D. | Average | S.D. |
| 1 | | | | | | |
| 2 | | | | | | |
| 3 | | | | | | |
| 4 | 3.928 | 0.957 | 0.280 | 0.080 | 7.2 | 0.7 |
| 5 | 3.795 | 0.353 | 0.222 | 0.029 | 9.0 | 1.1 |
| 6 | 7.347 | 1.021 | 0.408 | 0.052 | 6.5 | 2.1 |
| 7 | 7.735 | 0.958 | 0.329 | 0.049 | 7.1 | 1.0 |
| 8 | 8.180 | 0.564 | 0.326 | 0.056 | 11.2 | 2.0 |
| 9 | 6.514 | 1.382 | 0.211 | 0.041 | 8.0 | 0.9 |

| | Dry Elongation | | Wet Elongation | | Dry TEA | | Wet TEA | |
|---|---|---|---|---|---|---|---|---|
| Sample | % | | % | | J/m\hat{ }2 | | J/m\hat{ }2 | |
| ID | Average | S.D. | Average | S.D. | Average | S.D. | Average | S.D. |
| 1 | | | | | | | | |
| 2 | | | | | | | | |
| 3 | | | | | | | | |
| 4 | 3.425 | 0.921 | 3.150 | 0.911 | 61.332 | 13.901 | 3.112 | 1.060 |
| 5 | 3.453 | 0.557 | 2.657 | 0.497 | 50.540 | 5.165 | 2.266 | 0.626 |
| 6 | 2.849 | 0.713 | 2.019 | 0.478 | 71.247 | 15.487 | 3.305 | 1.135 |
| 7 | 2.820 | 0.418 | 2.228 | 0.466 | 78.577 | 19.135 | 3.086 | 0.841 |
| 8 | 3.356 | 0.527 | 2.076 | 0.564 | 105.848 | 19.345 | 3.030 | 1.268 |
| 9 | 2.299 | 0.549 | 2.262 | 0.367 | 60.483 | 26.021 | 1.995 | 0.512 |

### Example 2—Manufacturing Methods for Paper-Based Sorbents

The paper-based sorbent sheet materials of the present disclosure, such as those listed in Table 1, can be manufactured using any of a variety of methods known to those of skill in the art. The flexible sheets of the materials used for the tests described in Example 1 were prepared as follows.

Handsheets were formed using Noble & Wood Handsheet forming equipment using manufacturer's procedure. Forming box size is 8″×8″ sheets. Stock volumes were proportioned to manufacture 400 gsm fiber sheets. Drainage from the forming box was under pumping power for collection of white water. White water was allowed to build up from the wet formation of the first 3 sheets, which were discarded. Recirculated white water was used for the dilution water to form all subsequent sheets. The wet formed sheets on the wire were pressed once, then sent around the drying drum one time on the wire, then the sheet was removed from the wire and dried two more times around the drying drum. The sheets were then allowed to condition in a TAPPI conditioning room for 48 hours.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A flexible sheet of a composite material adapted to adsorb carbon dioxide from a gaseous flow comprising: 40% to 80% by weight of a fiber component and 10% to 50% by weight of a strong base anion exchange resin component formulated into a sheet material having a weight ranging from about 100 gsm to about 400 gsm.

2. The flexible sheet of claim 1, wherein the strong base anion exchange resin is a Type I strong base anion exchange resin.

3. The flexible sheet of claim 2, wherein the Type I strong base anion exchange resin is selected from the group consisting of Purolite® A500, Dowex™ Marathon™ A (OH form), ResinTech SBMP1 (OH form), Rohm & Haas Amberlite IRA402 (OH form), and Rohm & Haas Amberlite 900 (OH form).

4. The flexible sheet of claim 1, wherein the fiber component comprises about 35% to about 65% by weight of a natural fiber and about 35% to about 65% by weight of a synthetic fiber.

5. The flexible sheet of claim 1, wherein the fiber component comprises a natural fiber selected from the group consisting of lignocellulosic fibers, natural fibers derived from wood, wheat, rice, reed, hemp, flax, cotton, bagasse, bamboo, grass, sorghum, or kenaf, a recovered fiber, and recycled fiber, or any combination thereof.

6. The flexible sheet of claim 5, wherein the lignocellulosic fiber is selected from the group consisting of cellulose, hemicellulose, and lignin.

7. The flexible sheet of claim 1, wherein the fiber component comprises a synthetic fiber selected from the group consisting of polyester fiber, polyolefin fiber, acrylic fiber, aramid fiber, 5d30, cyphrex, and vinylon, or any combination thereof.

8. The flexible sheet of claim 7, wherein the polyolefin fiber is polypropylene or polyethylene.

9. The flexible sheet of claim 1, wherein the fiber component comprises about 27% to 33% by weight of cotton and about 27% to 33% by weight of 1.5 polyester.

10. The flexible sheet of claim 1, further comprising one or more process additives selected from the group consisting of retention and drainage aids, biocides, dispersants, and defoamers.

11. The flexible sheet of claim 1, further comprising one or more functional additives selected from the group consisting of fillers, binders, bonding agents, thickening and stabilizing agents, sizing agents, wet-strength additives, and dry-strength additives.

12. The flexible sheet of claim 11, wherein the one or more functional additives are selected from the group consisting of wet strength additives, cationic starches, and guar gum.

13. The flexible sheet of claim 12, wherein the one or more functional additives comprise polyamide epichlorohydrin (PAE).

14. The flexible sheet of claim 9, further comprising about 1% to 2% by weight of polyamide epichlorohydrin (PAE).

15. A collector system for the capture of CO₂ from ambient air, wherein the collector system comprises the flexible sheets of claim 1.

16. A flexible sheet of a material adapted to adsorb carbon dioxide from a gaseous flow, wherein said material is formed by a process comprising: (1) combining 20% to 40% by weight of a natural fiber, 20% to 40% by weight of a synthetic fiber, 10% to 50% by weight of a strong base anion exchange resin, and 5% to 20% by weight of a liquid to form a slurry; (2) forming a wet sheet by distributing the slurry onto a planar flat surface; and (3) simultaneously and/or sequentially draining liquid from the distributed slurry, applying pressure to the wet sheet, and drying the wet sheet.

17. The flexible sheet of claim 16, wherein the natural fiber is selected from the group consisting of cellulosic fibers and natural fibers derived from wood, wheat, rice, reed, hemp, flax, cotton, bagasse, bamboo, grass, sorghum, kenaf, a recovered fiber, and recycled fiber, or any combination thereof.

18. The flexible sheet of claim 17, wherein the cellulosic fiber is cellulose or hemicellulose.

19. The flexible sheet of claim 16, wherein the synthetic fiber is selected from the group consisting of polyester fiber, polyolefin fiber, acrylic fiber, aramid fiber, 5d30, cyphrex, and vinylon, or any combination thereof.

20. The flexible sheet of claim 19, wherein the polyolefin fiber is polypropylene or polyethylene.

21. The flexible sheet of claim 16, wherein the strong base anion exchange resin is a Type I strong base anion exchange resin.

22. The flexible sheet of claim 21, wherein the Type I strong base anion exchange resin is selected from the group consisting of Purolite® A500, Dowex™ Marathon™ A (OH form), ResinTech SBMP1 (OH form), Rohm & Haas Amberlite IRA402 (OH form), and Rohm & Haas Amberlite 900 (OH form).

23. A collector system for the capture of CO₂ from ambient air, wherein the collector system comprises any of the flexible sheet claim 16.
